(19) United States
(12) Patent Application Publication
(10) Pub. No.: US 2026/0018949 A1
(43) Pub. Date: Jan. 15, 2026

(54) PERMANENT MAGNET-TYPE ROTARY ELECTRIC MACHINE

(71) Applicant: Mitsubishi Electric Mobility Corporation, Tokyo (JP)

(72) Inventors: Hitoshi ISODA, Tokyo (JP); Shinsuke KAYANO, Tokyo (JP); Junji KITAO, Tokyo (JP); Takeshi KUBOTA, Tokyo (JP)

(73) Assignee: Mitsubishi Electric Mobility Corporation, Tokyo (JP)

(21) Appl. No.: 19/111,962

(22) PCT Filed: Oct. 13, 2022
(86) PCT No.: PCT/JP2022/038208

§ 371 Date: Mar. 14, 2025

(51) Int. Cl. H02K 1/276; H02K 1/32

(52) U.S. Cl. CPC H02K 1/2766; H02K 1/32

(57) ABSTRACT

The distance formed between surfaces facing in the thickness direction of the permanent magnet is set to be larger than the thickness of the permanent magnet, whereby gaps are formed between the permanent magnet and the magnet insertion holes. The magnet insertion hole of the first rotor core has formed therein a guide portion for positioning the permanent magnet. The magnet insertion hole of the second rotor core has formed therein an opening portion that connects the gap and the flux barrier to each other. The first rotor core and the second rotor core are laminated together in a mixed manner in the axis direction.

### TECHNICAL FIELD

The present disclosure relates to a permanent magnet-type rotary electric machine.

### BACKGROUND ART

The rotor structure of a permanent magnet-type rotary electric machine includes a first rotor core where permanent magnet insertion holes are formed, with a guide portion provided to regulate the position of the permanent magnet in the permanent magnet insertion hole, and a second rotor core in which there is no guide portion and only a permanent magnet insertion hole is formed, and these first and second rotor cores are combined and laminated in the axial direction in multiple layers, and the permanent magnets are press-fit into each permanent magnet insertion hole so as to pass through it in the axial direction, thereby holding the magnets in place and suppressing demagnetization of the permanent magnets caused by the magnetic flux flowing through the permanent magnets by the guide portion (see, for example, Patent Document 1 below).

### CITATION LIST

### Patent Document

Patent Document 1: Japanese Laid-Open Patent Publication No. 2016-1933

### SUMMARY OF THE INVENTION

### Problem to be Solved by the Invention

In the rotor of the conventional permanent magnet-type rotary electric machine, no gap exists between the permanent magnet insertion hole of the rotor core and the permanent magnet, and the permanent magnet is press-fitted into the magnet insertion hole to form the rotor, which can cause damage such as cracking and chipping of the permanent magnet. In addition, if the permanent magnet is coated with an anti-rust coating, the coating can peel off and cause the permanent magnet to rust, and the permanent magnet cannot be smoothly inserted into the permanent magnet insertion hole. Furthermore, press-fitting the permanent magnet into the rotor core can stress the rotor core and which can lead to damage to the rotor core.

Moreover, in a configuration in which the magnet insertion hole and magnet have a V-shaped configuration protruding radially inward, due to the small number of rotor cores with guide portions for holding the magnets on the outer diameter side, when centrifugal force is generated from the permanent magnet during rotor rotation, the stress applied to the guide portions formed in the permanent magnet insertion holes increases, which could result in damage to the rotor core.

This disclosure aims to provide a technology to solve the aforementioned problems and offer a permanent magnet-type rotary electric machine that facilitates the insertion of permanent magnets into the magnet insertion holes of the rotor core, prevents damage to the magnets during insertion, and enhances the rotor's strength without applying excessive stress to the rotor core.

### Means to Solve the Problem

A permanent magnet-type rotary electric machine, comprising a stator and a rotor rotatably supported by a rotating shaft inside the stator. The rotor has a rotor core formed by laminating a plurality of electromagnetic steel plates in the axial direction. The rotor core includes a plurality of magnet insertion holes formed therein, the magnet insertion holes being mounted with a strip-shaped permanent magnet passing through in the axial direction. The rotor core has a first rotor core and a second rotor core. The magnet insertion holes formed in the first and second rotor cores are provided with flux barriers on both sides of the permanent magnet in the width direction to prevent flux leakage. A gap is formed between the permanent magnet and the magnet insertion holes by setting the distance between the facing surfaces in the thickness direction of the permanent magnet to be greater than the thickness of the permanent magnet. The magnet insertion hole of the first rotor core is provided with a guide portion for positioning in the width direction of the permanent magnet formed on at least one end side in the width direction of the permanent magnet. The magnet insertion hole of the second rotor core has an opening portion that communicates with the gap and the flux barrier. The first and second rotor cores are laminated in a mixed manner in the axial direction.

### Effect of the Invention

According to the permanent magnet-type rotary electric machine disclosed in the present disclosure, the insertion of permanent magnets into the magnet insertion holes of the rotor core is made easier, preventing damage to the magnets during insertion and enhancing the rotor's strength without applying excessive stress to the rotor core.

### BRIEF DESCRIPTION OF THE DRAWINGS

FIG. 1 is a cross-sectional view perpendicular to the rotation axis of the permanent magnet-type rotary electric machine according to embodiment 1.

FIG. 2 is an enlarged cross-sectional view of one magnetic pole of the first rotor core of the permanent magnet-type rotary electric machine according to embodiment 1.

FIG. 3 is an enlarged cross-sectional view of one magnetic pole of the second rotor core of the permanent magnet-type rotary electric machine according to embodiment 1.

FIG. 4 is an enlarged cross-sectional view of one magnetic pole in which the permanent magnet is attached to a first rotor core of the permanent magnet-type rotary electric machine according to embodiment 1.

FIG. 5 is an enlarged cross-sectional view of one magnetic pole in which the permanent magnet is attached to the second rotor core of the permanent magnet-type rotary electric machine according to embodiment 1.

FIG. 6 is an enlarged cross-sectional view showing a state in which the permanent magnet is attached to one magnet insertion hole of the first rotor core of the permanent magnet-type rotary electric machine according to embodiment 1.

FIG. 7 is an enlarged cross-sectional view showing a state in which the permanent magnet is attached to one magnet insertion hole of the second rotor core of the permanent magnet-type rotary electric machine according to embodiment 1.

FIG. 8 is a cross-sectional view along line A-A in FIGS. 6 and 7.

FIG. 9 is an enlarged cross-sectional view showing a flow of resin injected into a second rotor core of the permanent magnet-type rotary electric machine according to embodiment 1.

FIG. 10 is an enlarged cross-sectional view showing a modified example of the second rotor core according to embodiment 1, showing a state in which the permanent magnet is attached to one magnet insertion hole.

FIG. 11 is an enlarged cross-sectional view showing another modified example of the second rotor core according to embodiment 1, showing a state in which the permanent magnet is attached to each magnet insertion hole.

FIG. 12 is an enlarged cross-sectional view of one magnetic pole in which the permanent magnet is attached to a first rotor core of the permanent magnet-type rotary electric machine according to embodiment 2.

FIG. 13 is an enlarged cross-sectional view of one magnetic pole in which the permanent magnet is attached to a second rotor core of a permanent magnet-type rotary electric machine according to embodiment 2.

FIG. 14 is a cross-sectional view along line B-B in FIGS. 12 and 13.

FIG. 15 is an enlarged cross-sectional view showing a flow of fluid relative to the second rotor core of the permanent magnet-type rotary electric machine according to embodiment 2.

### DESCRIPTION OF EMBODIMENTS

### Embodiment 1

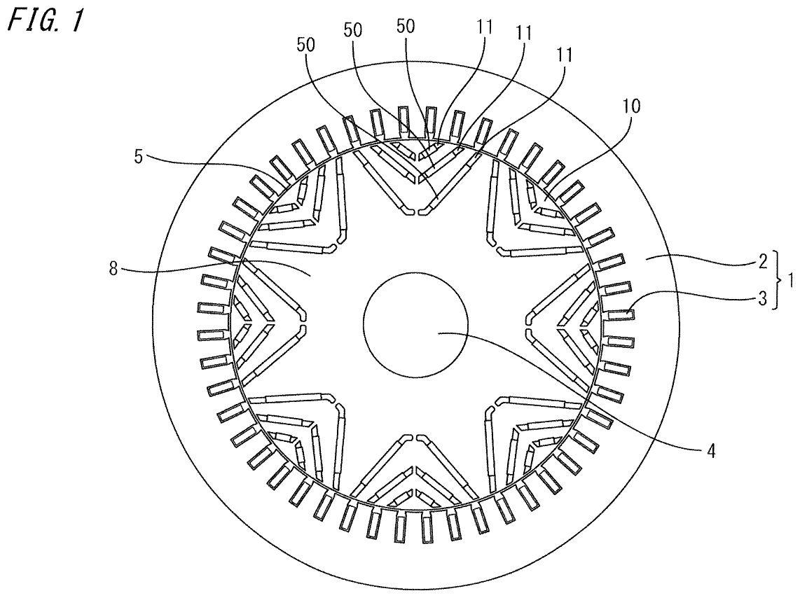

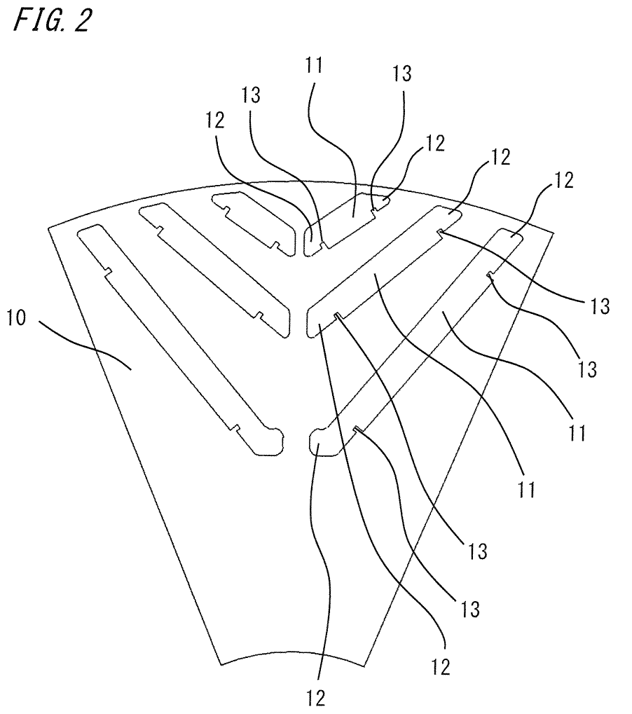

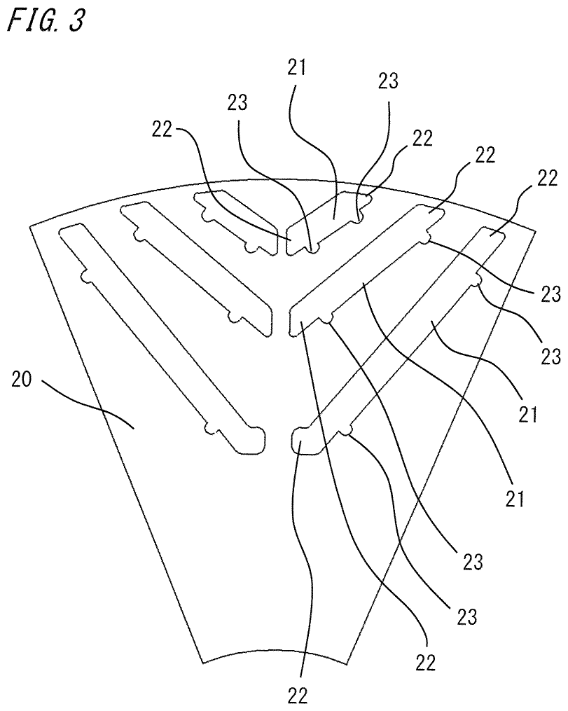

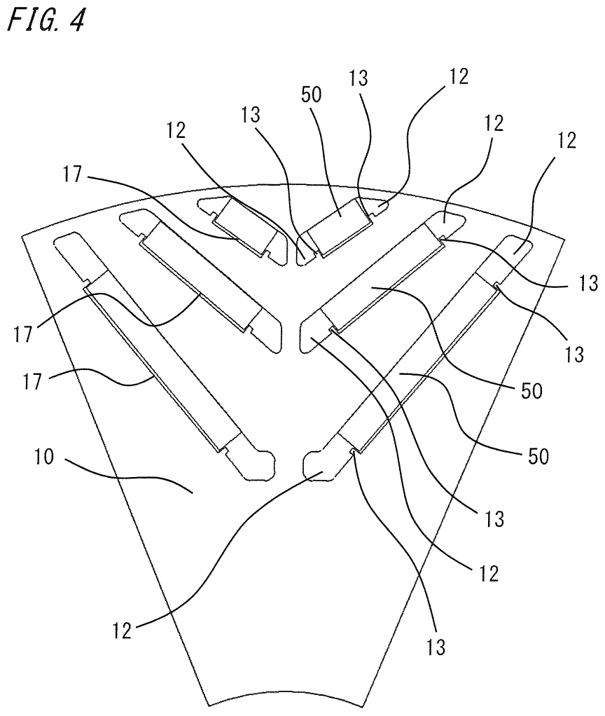

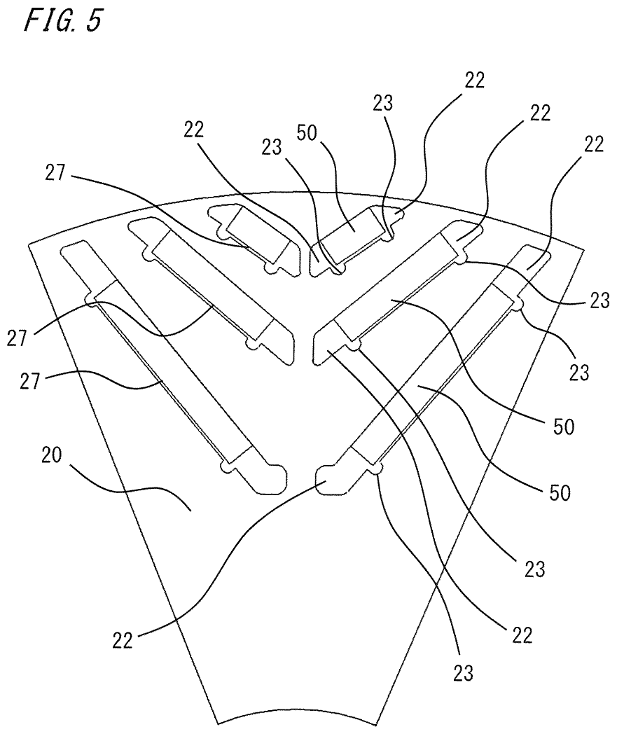

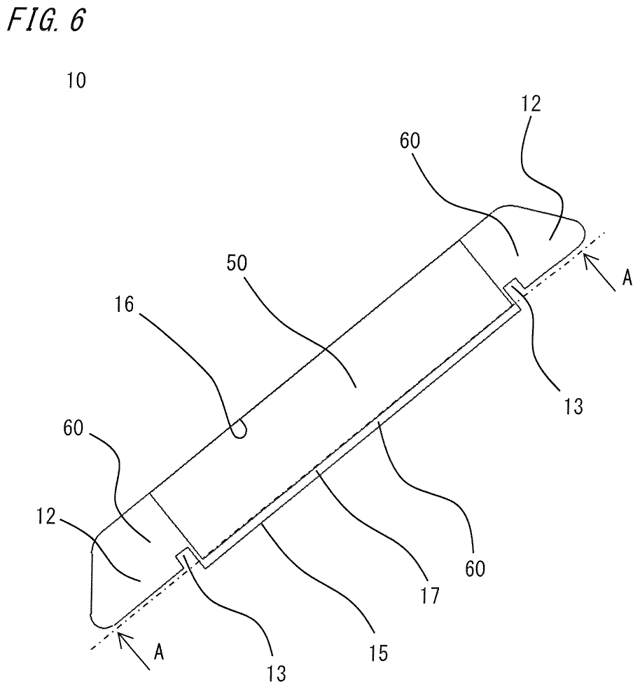

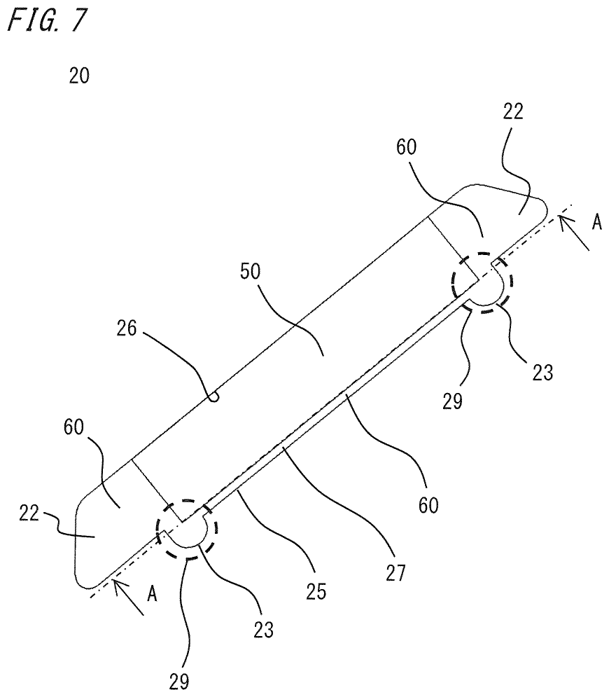

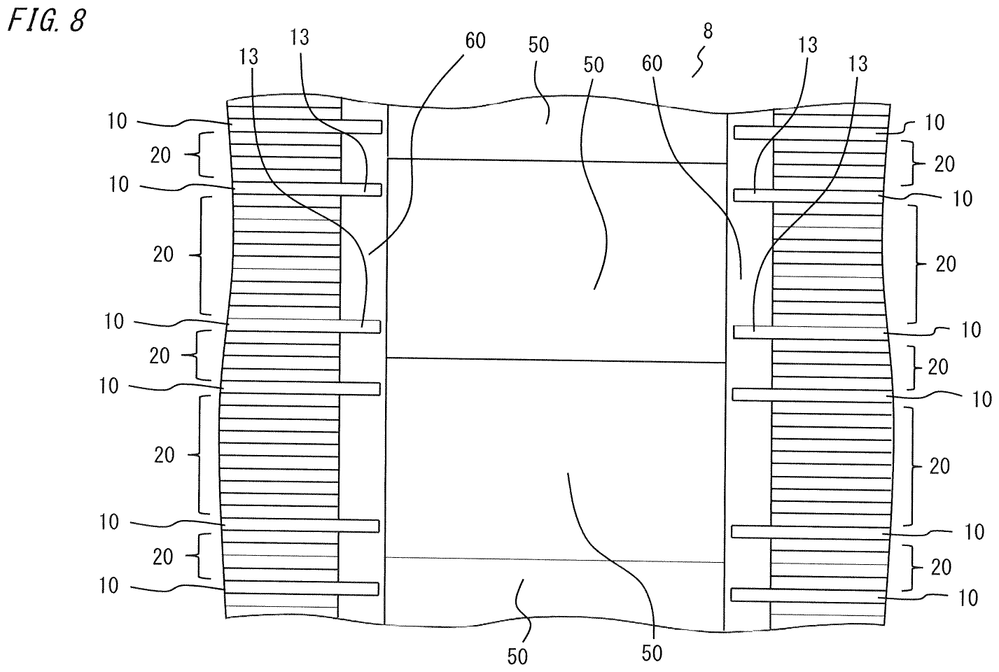

FIG. 1 is a cross-sectional view perpendicular to the rotation axis of the permanent magnet-type rotary electric machine according to embodiment 1, FIG. 2 is an enlarged cross-sectional view of one magnetic pole of the first rotor core of the permanent magnet-type rotary electric machine according to embodiment 1, FIG. 3 is an enlarged cross-sectional view of one magnetic pole of the second rotor core of the permanent magnet-type rotary electric machine according to embodiment 1, FIG. 4 is an enlarged cross-sectional view of one magnetic pole with the permanent magnet attached to the first rotor core of the permanent magnet-type rotary electric machine according to embodiment 1, FIG. 5 is an enlarged cross-sectional view of one magnetic pole with the permanent magnet attached to the second rotor core of the permanent magnet-type rotary electric machine according to embodiment 1, FIG. 6 is an enlarged cross-sectional view showing a state in which the permanent magnet is attached to one magnet insertion hole of the first rotor core, FIG. 7 is an enlarged cross-sectional view showing a state in which the permanent magnet is attached to one magnet insertion hole of the second rotor core, and FIG. 8 is a cross-sectional view along line A-A in FIG. 6 and FIG. 7.

As shown in FIG. 1, the permanent magnet-type rotary electric machine according to the first embodiment of the present disclosure has a stator 1 provided on the outer periphery, and a rotor 5 rotatably supported by a rotating shaft on the inside of the stator 1.

The stator 1 is configured with a stator core 2 and a coil 3 wound around the stator core 2.

On the other hand, the rotor 5 is configure with a rotor core 8 and a permanent magnet 50, and in this embodiment 1, the rotor core 8 includes a first rotor core 10 and a second rotor core 20, both of which are made of electromagnetic steel plate, and the first rotor core 10 and the second rotor core 20 are laminated in multiple pieces in the axial direction of the rotor 5, as described below.

As shown in FIGS. 2 to 5, the first rotor core 10 and the second rotor core 20 are each formed with magnet insertion holes 11, 21 of the same pole in a V-shaped configuration protruding radially inward when viewed from the outer periphery of the rotor 5. That is, each magnet insertion hole 11, 21 is formed in a V-shaped configuration such that the circumferential distance between the six magnet insertion holes 11, 21 arranged for one pole gradually increases toward the outer periphery of the rotor, and a pair of magnet insertion holes 11, 21 has three-layer structure in the radial direction, with through-holes penetrating in the axial direction. A permanent magnet 50 is attached to each magnet insertion hole 11, 21. The above configuration constitutes one magnetic pole of the rotating electric machine. In addition, the permanent magnets 50 forming two adjacent magnetic poles are arranged so that the N pole and the S pole are reversed with respect to each other.

The permanent magnet 50 has a rectangular strip shaped cross-section that is perpendicular to the axial direction of the rotor 5 as viewed in a plan view, and as shown in FIG. 8, in order to reduce loss of the permanent magnet 50, it is divided into a predetermined number of parts in the axial direction and arranged in each of the magnet insertion holes 11, 21 of the first rotor core 10 and the second rotor core 20. That is, in this embodiment 1, the first rotor core 10 is arranged at both ends of one divided permanent magnet 50 with respect to its axial center, and the second rotor core 20 is arranged between the first rotor cores 10.

In this way, at least one first rotor core 10 is arranged in a range corresponding to the axial length of the divided permanent magnet 50, and the first rotor core 10 and the second rotor core 20 are laminated in a mixed manner in the axial direction to form the rotor core 8.

Focusing on the individual magnet insertion holes 11, 21 of the first rotor core 10 and the second rotor core 20, each magnet insertion hole 11, 21 is provided with flux barriers 12, 22 on both sides in the width direction of the permanent magnet 50 to prevent flux leakage.

In addition, the magnet insertion holes 11, 21 of the first rotor core 10 and the second rotor core 20 are set so that the distance between the surfaces facing each other in the thickness direction (short side direction) of the permanent magnet 50 is greater than the thickness of the permanent magnet 50. As a result, gaps 17, 27 are formed between the inner surfaces 15, 25 on the radially inner side of the long side of the magnet insertion holes 11, 21 and the radially inner surface on the long side of the permanent magnet 50 facing the inner surfaces. In this case, the gaps 17, 27 are set to a dimension that allows the resin to flow in a fluid state, as described later. For example, the gaps are set to be about several tens of um to several hundreds of μm. At least a portion of the radially outer surfaces 16, 26 on the long side of the magnet insertion holes 11, 21 and the radially outer surface on the long side of the permanent magnet 50 facing the surfaces 16,26 are in contact with each other.

In addition, in this embodiment 1, with regard to the magnet insertion hole 11 of the first rotor core 10, as shown in FIG. 2, FIG. 4, and FIG. 6, in order to regulate the widthwise (long side) position of the permanent magnet 50 inside the magnet insertion hole 11, on the inner surface 15 in the radial direction on the long side of the magnet insertion hole 11, each guide portions 13 is formed to protrude into the interior of the magnet insertion hole 11 at positions that face each other at the corners of both ends of the long side of the permanent magnet 50.

In this case, since the length between the left and right guide portions 13 needs to regulate the position of the permanent magnet 50 in the long side direction, the difference in dimensions between the distance of the two guide portions 13 and the width (length of the long side) of the permanent magnet 50 is set to, for example, about several tens of um to several hundreds of um so as not to deteriorate the insertability of the permanent magnet 50 into the rotor core 8.

On the other hand, with regard to the magnet insertion hole 21 of the second rotor core 20, as shown in FIG. 3, FIG. 5, and FIG. 7, on the inner surface 25 in the radial direction on the long side of the magnet insertion hole 21, recessed portion 23 that bulge radially inward at positions opposite the corners at both ends of the long side of the permanent magnet 50, such that the recessed portion each span across the corners of the permanent magnet 50.

In this way, the magnet insertion hole 21 of the second rotor core 20 is formed by placing the recess portion 23 at a position opposite the corner of the permanent magnet 50 instead of the guide portion 13 as in the first rotor core 10, thereby forming an opening portion 29 that communicates with the flux barrier 22 from the gap 27 between the permanent magnet 50 and the magnet insertion hole 21, as shown in FIG. 7.

By adopting the above configuration, the permanent magnets 50 can be easily inserted into the magnet insertion holes 11 and 21 of the first rotor core 10 and the second rotor core 20, eliminating breakage during insertion, improving the insertability of the permanent magnets 50, and improving productivity. In addition, no excessive stress is applied to the rotor core 8, improving the strength of the rotor core 8. Moreover, by mixing the first rotor core 10 and the second rotor core 20 in the axial direction, it becomes possible to regulate the position of the permanent magnets 50 in the width direction (long side direction) for each of the permanent magnets 50 divided into multiple parts in the axial direction.

Additionally, in this embodiment 1, as shown in FIG. 6 to FIG. 8, the space including the flux barriers 12 and 22, gaps 17 and 27, and recessed portions 23 between the magnet insertion holes 11, 21 and the permanent magnet 50 is filled with resin 60, which is a non-magnetic material.

To fill the interior of the magnet insertion holes 11 and 21 with resin 60, for example, after the permanent magnets 50 are inserted into the magnet insertion holes 11 and 21, a gate for injecting resin is placed at the axial end of the rotor core 8 where the flux barriers 12 and 22 are located, and the resin is injected from the core end on one axial end side of the flux barriers 12 and 22 while the resin 60 is in a fluid state. At that time, the openings of the flux barriers 12 and 22 on the other axial opposite end side are kept blocked.

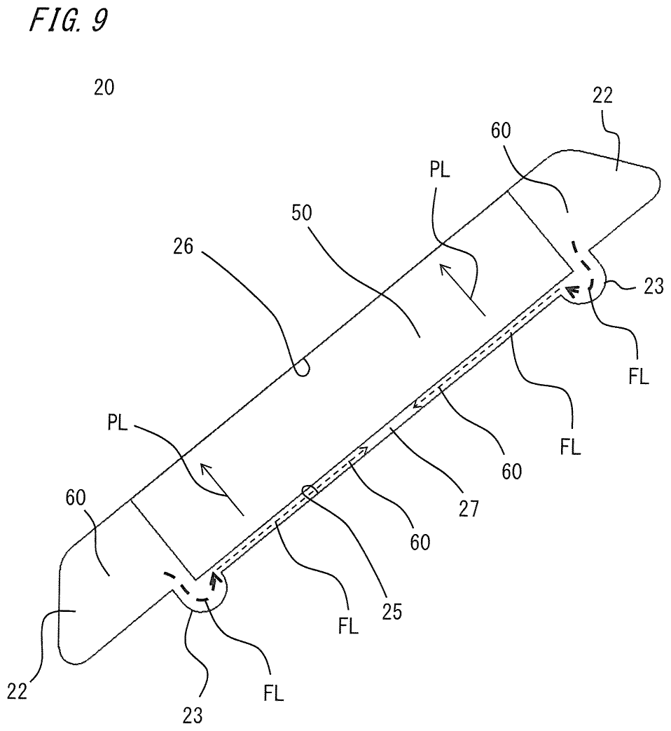

Then, the resin that flows into the flux barriers 12 and 22, as shown by the dashed arrows FL in FIG. 9, first flows mainly into the recesses 23 that serve as the opening portions 29 of the second rotor core 20, and generates a force that presses the permanent magnets 50 radially outward in a direction parallel to the thickness direction (short side direction), as shown by the solid arrows PL in FIG. 9. Then, the radially outer surface of the long side of the permanent magnet 50 is pressed against the radially outer surface 26 of the long side of the magnet insertion hole 21, which faces it. As a result, a gap 27 forms between the radially inner surface 25 of the long side of the magnet insertion hole 21 and the radially inner surface of the long side of the permanent magnet 50, which faces it, and the resin flows into and fills the gap 27. Furthermore, due to the presence of the second rotor core 20, the resin that has flowed into the gap 27 between the permanent magnets 50 and the magnet insertion holes 21 also flows out along the axial direction, and the resin also fills the gap 17 between the permanent magnets 50 and the magnet insertion holes 11 of the first rotor core 10. Thereafter, by the resin hardens, the permanent magnets 50 are fixed at predetermined positions inside the magnet insertion holes 11 and 21 of the first rotor core 10 and the second rotor core 20, respectively.

In this way, in both the first rotor core 10 and the second rotor core 20, the resin 60 fills the entire gaps 17 and 27 between the radially inner surface of the long side of the permanent magnet 50 and the opposing radially inner surfaces 15 and 25 of the long side of the magnet insertion holes 11 and 21, thereby securing the permanent magnet 50. This improves the strength of the adhesive bond for the permanent magnet 50.

If the rotor core were constructed solely of the first rotor core 10 without the inclusion of the second rotor core 20, there would be no opening to form a flow path connecting the flux barrier 12 to the gap 17, which would prevent the resin from flowing in sufficiently into the gap 17 between the permanent magnets 50 of the first rotor core 10 and the magnet insertion holes 11. This would result in the permanent magnets 50 being fixed in an unstable position in their thickness direction (short side direction).

In contrast, when the rotor core 8 is configured to include not only the first rotor core 10 but also the second rotor core 20 as in the first embodiment, the position of the permanent magnet 50 in its thickness direction (short side direction) is stabilized. Moreover, since the radially outer surface of the long side of the permanent magnet 50 is pressed against the corresponding radially outer surface 26 of the long side of the magnet insertion hole 21, the magnetic force of the permanent magnet 50 can be utilized more effectively than when the radially inner surface of the long side of the permanent magnet 50 is pressed against the radially inner surface 25 of the magnet insertion hole 21. This configuration makes it possible to suppress a decrease in torque of the permanent magnet-type rotary electric machine.

In addition, by filling the gaps 17 and 27 between the permanent magnets 50 and the magnet insertion holes 11 and 21 with resin 60, the heat generated by the permanent magnets 50 can be transmitted to the portion of the rotor core 8 that is located inside the permanent magnets 50 via the resin, it is possible to suppress an increase in temperature of the permanent magnets 50.

Furthermore, in a configuration like the embodiment 1, where the magnet insertion holes 11 and 21 is formed in a V-shaped configuration such that the circumferential distance between the magnet insertion holes 11 and 21 increases toward the outer periphery of the rotor 5, when centrifugal force generated in the permanent magnets 50 as the rotor 5 rotates, the centrifugal force is supported not only by the left and right guide portions 13 of the first rotor core 10 but also by the resin 60 filling the left and right flux barriers 22 and the recesses 23 of the second rotor core 20, thereby preventing damage to the guide portions 13 of the first rotor core 10.

As described above, in the permanent magnet-type rotary electric machine according to the first embodiment, the first rotor core 10 and the second rotor core 20 are laminated in a mixed manner along the axial direction to form the rotor core 8. In this configuration, the gaps 17 and 27 are formed between the permanent magnets 50 and the magnet insertion holes 11 and 21, allowing for the easy insertion of the permanent magnets 50 into the magnet insertion holes 11 and 21. As a result, the permanent magnets 50 are not damaged when the magnets are inserted, and productivity is improved. In addition, no additional stress is applied to the rotor core 8 during the insertion of the permanent magnets 50, and the strength of the rotor core 8 is improved. Moreover, a flow path is secured for flowing the resin from the flux barrier 22 of the second rotor core 20 through the opening portion 29 toward the gap 27 between the permanent magnets 50 and the magnet insertion holes 21, which is advantageous in improving the adhesive strength of the permanent magnets 50.

### (Modification of Embodiment 1)

Moreover, the following modification of the above-described first embodiment can be considered.

In the above-mentioned embodiment 1, the pair of V-shaped magnet insertion holes 11 and 21 is formed in three layers in the radial direction, with a permanent magnet 50 installed inside each magnet insertion hole 11 and 21. In the case of such a three-layer structure, the distance between the opposing inner surfaces 15 and 16 of the long side of the magnet insertion hole 11, and the distance between the inner surfaces 25 and 26, as well as the thickness of the permanent magnet 50 in the short side direction are smaller than in the case of a single-layer structure or a two-layer structure. This configuration helps suppress demagnetization of the permanent magnet 50 caused by the magnetic flux flowing from the guide portion 13 to the permanent magnet 50, which is preferable, but is not limited to this structure, and a single-layer structure or a two-layer structure may also be used. Moreover, the magnet insertion holes 11 and 21 may not be in a V shaped configuration, but may be in a flat plate configuration parallel to the circumferential direction.

In addition, the recessed portion 23 provided in the second rotor core 20 expands the flow path from the flux barrier 22 to the permanent magnet 50 and the gap 27, thereby facilitating the flow of resin through it. This forms an advantageous structure for enhancing the adhesive strength of the permanent magnet 50.

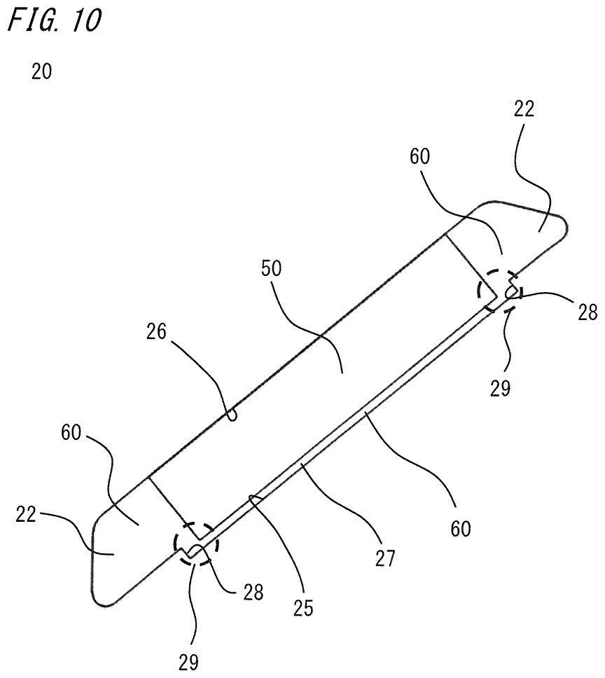

However, not limited to this configuration, for example, as shown in FIG. 10, a step portion 28 may be provided in the magnet insertion hole 21 of the second rotor core 20 at a position outward from the corners at both ends of the long side of the permanent magnet 50. The gap between this step portion 28 and the corners at both ends of the long side of the permanent magnet 50 may be formed as an opening portion 29.

With this configuration, the opening portion 29 of a width that does not significantly impede the flow of fluid is formed between the corner of the permanent magnet 50 and the step portion 28, making it possible to ensure a path for resin to flow from the flux barrier 22 through the opening portion 29 and into the gap 27 between the permanent magnet 50 and the magnet insertion hole 21, thereby obtaining the same effect as when the recessed portion 23 is provided.

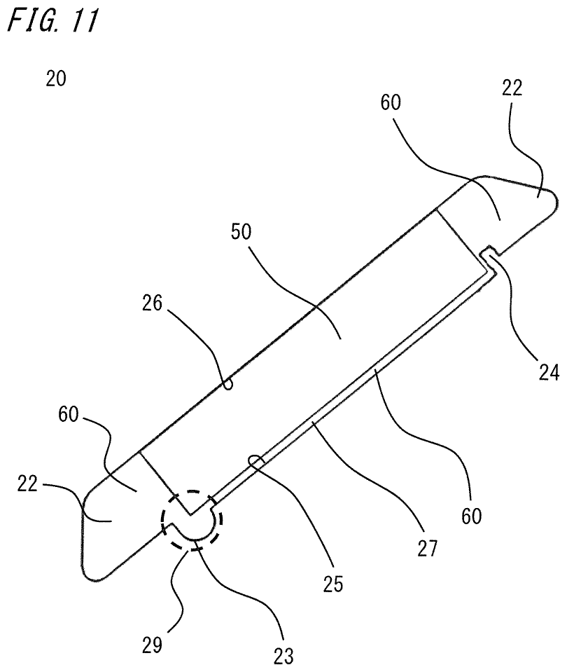

In addition, for either the first rotor core 10 or the second rotor core 20, for example, at the second rotor core 20, as shown in FIG. 11, a guide portion 24 may be provided to regulate the position of the permanent magnet 50 to face the corner at one end of the long side of the permanent magnet 50, and an opening portion 29, consisting of a recessed portion 23, can be provided at a position facing the corner at the other end of the long side of the permanent magnet 50.

Even in this configuration, it is possible to utilize the gap 27 between the permanent magnet 50 and the magnet insertion hole 21 through the opening portion 29 from the flux barrier 22 as a flow path for flowing a fluid such as resin, and this configuration can achieve effects similar to those obtained in the case of a combination of the two types of rotor cores, the first rotor core 10 and the second rotor core 20, in this embodiment 1.

Furthermore, rotor core 8 is not limited to being composed of only two types of rotor cores, first rotor core 10 and second rotor core 20, but may also be composed by laminating rotor cores having a configuration as shown in FIG. 11 in addition to first and second rotor cores 10, 20 in an axially mixed manner. Moreover, not limited to the configuration shown in FIG. 11, it is also possible to use a shape that has at least a magnet insertion hole allowing the permanent magnet 50 to be inserted without obstruction, even if none of the characteristic configurations, such as the guide portion 13 or recessed portion 23, are formed.

### Embodiment 2

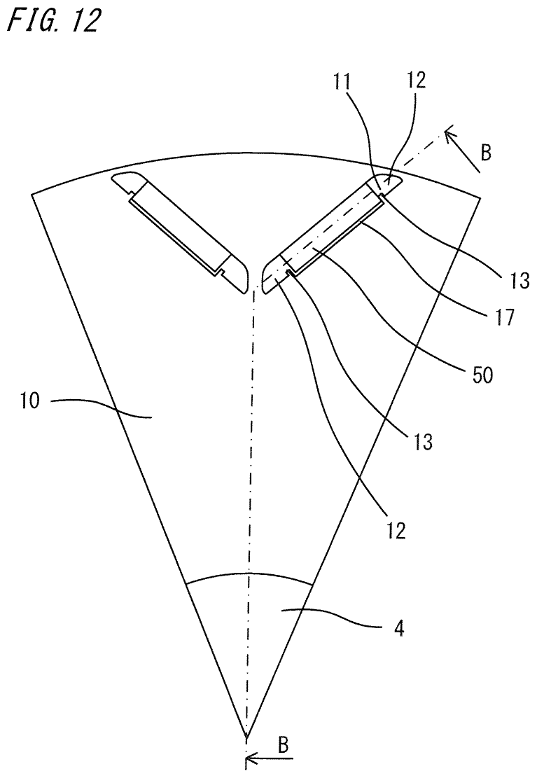

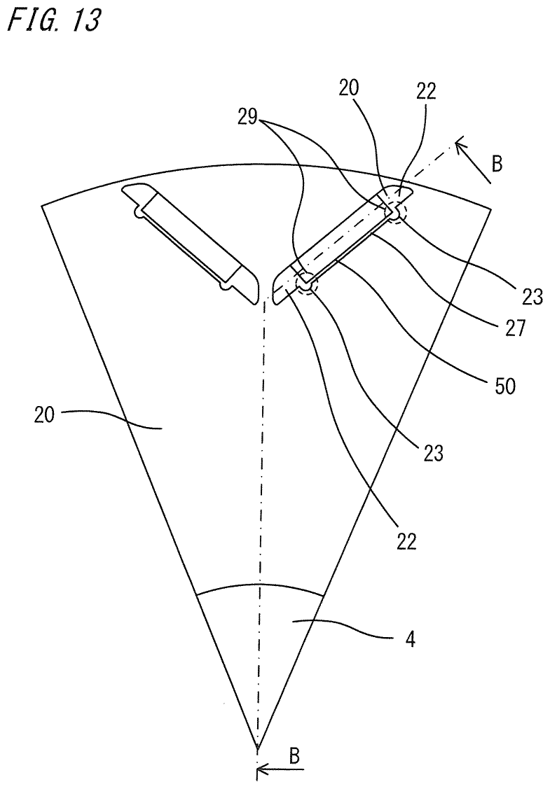

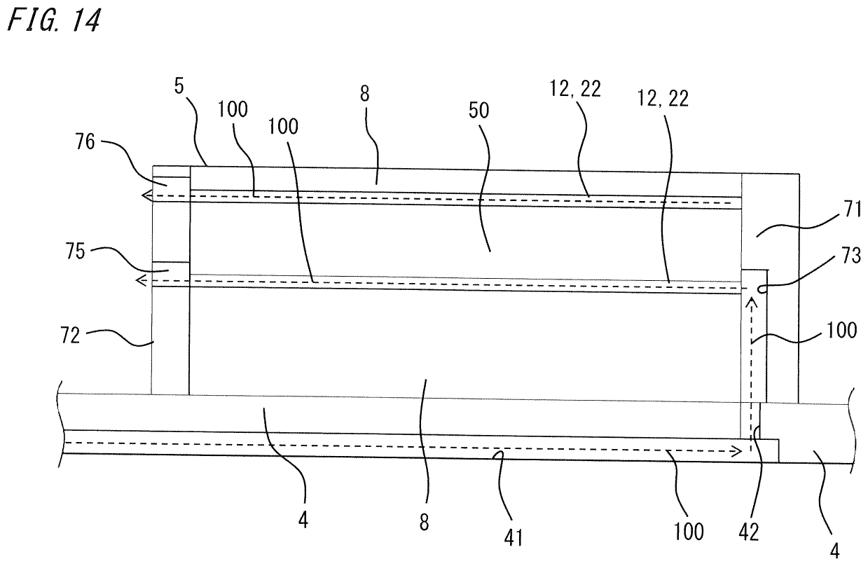

FIG. 12 is an enlarged cross-sectional view of one magnetic pole with a permanent magnet 50 attached to the first rotor core 10 of a permanent magnet-type rotary electric machine in embodiment 2, FIG. 13 is an enlarged cross-sectional view of one magnetic pole with a permanent magnet 50 attached to the second rotor core 20 of a permanent magnet-type rotary electric machine in embodiment 2, and FIG. 14 is a cross-sectional view along line B-B in FIG. 12 and FIG. 13.

In this embodiment 2, the rotor core includes the first rotor core 10 and the second rotor core 20, both made of electromagnetic steel plates. As shown in FIG. 12 and FIG. 13, a pair of magnet insertion holes 11 and 21 are formed in a V-shaped configuration, such that the circumferential distance between the pair of magnet insertion holes, arranged at one pole, gradually increases toward the outer periphery of the rotor.

In this case, unlike embodiment 1, the pair of magnet insertion holes 11 and 21 have a single-layer structure in the radial direction and are extend axially through the rotor. Each of the magnet insertion holes 11 and 21, similarly to embodiment 1, is equipped with a rectangular cross-section strip-shaped permanent magnet 50, which forms one magnetic pole of the rotary electric machine.

In this embodiment 2, similarly to the above embodiment 1, gaps 17 and 27 are formed between the flux barriers 12 and 22 and the permanent magnets 50 in each of the magnet insertion holes 11 and 21 of the first rotor core 10 and the second rotor core 20. Additionally, a guide portion 13 is formed in the magnet insertion hole 10 of the first rotor core 10, and a recessed portion 23 that serves as an opening portion 29 connecting the flux barrier 22 to the gap 27 is formed in the magnet insertion hole 21 of the second rotor core 20. The first rotor core 10 and the second rotor core 20, having the above configuration, are laminated to form the rotor core 8 in a mixed manner in the axial direction.

As a feature of the second embodiment, as shown in FIG. 14, end plates 71 and 72 are provided at both ends of the rotor 5 in the axial direction. In this case, one end plate 71 has a space 73 formed between itself and one end of the rotor core 8 in the axial direction, and this space 73 is in communication with the flux barriers 12 and 22 on the radial inner side of each of the magnet insertion holes 11 and 21 of the first rotor core 10 and the second rotor core 20. The other end plate 72 is formed with a pair of through holes 75 and 76 that penetrate toward the outside in the axial direction. One through hole 75 is configured to individually communicate with the flux barriers 12 and 22 on the radial inside of the magnet insertion holes 11 and 21, and the other through hole 76 is configured to individually communicate with the flux barriers 12 and 22 on the radial outside of the magnet insertion holes 11 and 21. Furthermore, the rotating shaft 4 is formed with a hollow portion 41 into which a fluid that serves as a refrigerant flows along the axial direction, and further formed with a through hole 42 that discharges the fluid from the hollow portion 41 into the space 73.

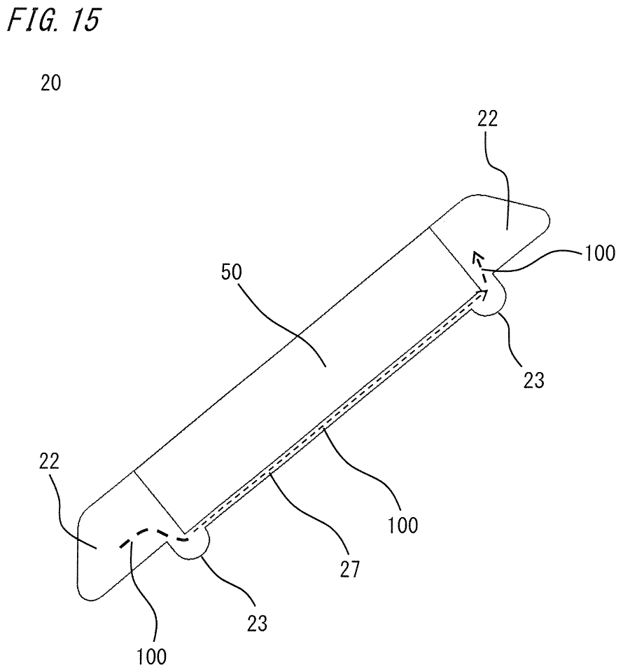

Therefore, the refrigerant fluid (for example, oil in this case) can flow from the hollow portion 41 of the rotating shaft 4 through the through hole 42 into the space, as shown by the dashed arrow in FIG. 14. The fluid then flows into one of the flux barriers 12 and 22 of the first rotor core 10 and the second rotor core 20, and is discharged to the outside of the rotor 5 through one of the through holes 75 of the end plate. Also, as shown by the dashed arrow 100 in FIG. 15, the fluid flows from one of the flux barriers 22 of the second rotor core 20 through the recessed portion 23 and the gap 27, which are openings, to the other flux barrier 22. Furthermore, the fluid flows out along the axial direction, also flows into the flux barrier 12 of the first rotor core 10, and is finally discharged to the outside of the rotor 5 through the other through hole 76 of the end plate 72.

With the above configuration, oil as a refrigerant not only flows through the flux barriers 12 and 22 of the first rotor core 10 and the second rotor core 20, but also flows through the recessed portions 23 of the second rotor core 20 into the gap 27 between the permanent magnet 50 and the flux barriers 12 and 22, as shown in FIG. 15. As a result, the area for directly cooling the permanent magnets 50 with oil can be increased, allowing for a reduction in the temperature of the permanent magnets 50. It should be noted that although oil has been exemplified as the refrigerant fluid here, the temperature of the permanent magnets 50 can also be reduced when air is used as the refrigerant. In the case of air, an external device (not shown) for flowing oil is not required, leading to cost reduction.

In this embodiment 2 as well, instead of providing a recessed portion 23 in the magnet insertion hole 21 of the second rotor core 20 at a position facing the corners at both ends of the long side of the permanent magnet 50, a configuration can be adopted in which a step portion 28 is provided at a position outward from the corners at both ends of the long side of the permanent magnet 50, as shown in FIG. 10, and the gap between this step portion 28 and the corners at both ends of the long side of the permanent magnet 50 is designated as the opening portion 29.

As described above, in the permanent magnet-type rotary electric machine of embodiment 2, similarly to the case of embodiment 1, there are the gaps 17 and 27 between the permanent magnet 50 and the magnet insertion holes 11 and 21, the permanent magnet 50 can be easily inserted into the magnet insertion holes 11 and 21, preventing damage to the permanent magnet 50 during insertion and improving productivity. In addition, no excessive stress is applied to the rotor core 8 when the permanent magnet 50 is inserted, improving the strength of the rotor core 8. Moreover, a flow path is secured for flowing a fluid such as a resin or a refrigerant from the flux barrier 22 toward the gap 27 between the permanent magnet 50 and the magnet insertion hole 21, which provides a structure that is advantageous for improving the adhesion strength of the permanent magnet 50 and improving cooling performance.

In embodiments 1 and 2 described above, the guide portions 13 of the magnet insertion holes 11 of the first rotor core 10 are provided at both ends of the long side of the permanent magnet 50, but they may also be provided at only one end of the long side. Similarly, the recessed portions 23 that serve as the opening 29 of the magnet insertion holes 21 of the second rotor core 20 are provided at both ends of the long side of the permanent magnet 50, but they may also be provided at only one end of the long side. Even in this case, the basic effects of the present disclosure described in the embodiments 1 and 2 can be similarly obtained.

Furthermore, in each of embodiments 1 and 2, the permanent magnet 50 has been described as having a rectangular cross section in a direction perpendicular to the axial direction in a plan view, but it is also possible to use a permanent magnet 50 having a curved cross section such as an arc shape. Even in the case of such a shape, by providing the guide portion 13 in the magnet insertion hole 11 of the first rotor core 10 and the recessed portion 23 that serves as an opening portion 29 in the magnet insertion hole 21 of the second rotor core 20, the same effects as those of embodiments 1 and 2 can be obtained.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 Stator
2 Stator core
4 Rotating shaft
5 Rotor
8 Rotor core
10 First rotor core
11 magnet insertion hole
12 Flux barrier
13 Guide portion
15 Inner surface
16 Inner surface
17 Gap
20 Second rotor core
21 magnet insertion hole
22 Flux barrier
23 Recessed portion
24 Guide portion
25 Inner surface
26 Inner surface
27 Gap
28 Step portion
29 Opening portion
50 Permanent magnet
60 Resin

1. A permanent magnet-type rotary electric machine, comprising:
a stator; and
a rotor rotatably supported by a rotating shaft inside the stator;
wherein
the rotor has a rotor core formed by laminating a plurality of electromagnetic steel plates in the axial direction,
the rotor core includes a plurality of magnet insertion holes formed therein, the magnet insertion holes being mounted with a strip-shaped permanent magnet passing through in the axial direction,
the rotor core has a first rotor core and a second rotor core,
the magnet insertion holes formed in the first and second rotor cores are provided with flux barriers on both sides of the permanent magnet in the width direction to prevent flux leakage,
a gap is formed between the permanent magnet and the magnet insertion holes by setting the distance between the facing surfaces in the thickness direction of the permanent magnet to be greater than the thickness of the permanent magnet,
the magnet insertion hole of the first rotor core is provided with a guide portion for positioning in the width direction of the permanent magnet formed on at least one end side in the width direction of the permanent magnet,
the magnet insertion hole of the second rotor core has an opening portion that communicates with the gap and the flux barrier, and
the first and second rotor cores are laminated in a mixed manner in the axial direction.

2. The permanent magnet-type rotary electric machine according to claim 1, wherein
the opening portion includes a recessed portion formed on an inner surface on the radially inner side at a position facing a corner of the permanent magnet; and
the recess portion is configured as the opening portion that straddles the corner of the permanent magnet.

3. The permanent magnet-type rotary electric machine according to claim 1, wherein
the gap is formed between the inner surfaces on the radially inner side of the magnet insertion hole and the radially inner surface of the permanent magnet facing the inner surface, and the flux barrier and the gap are filled with resin.

4. The permanent magnet-type rotary electric machine according to claim 3, wherein
at least a portion of the permanent magnet is in contact with an inner surface on a radially outer side of the magnet insertion hole.

5. The permanent magnet-type rotary electric machine according to claim 1, wherein
the magnet insertion holes and the permanent magnets are arranged in a V-shaped configuration that protrudes inward in the radial direction of the rotor.

6. The permanent magnet-type rotary electric machine according to claim 1, wherein
the magnet insertion holes and the permanent magnets are arranged in at least two layers in a radial direction of the rotor.

7. The permanent magnet-type rotary electric machine according to claim 1, wherein
the permanent magnet is divided into a plurality of parts in the axial direction of the rotor, and
at least one first rotor core is arranged within a range corresponding to the axial length of one of the divided permanent magnets.

8. The permanent magnet-type rotary electric machine according to claim 1, wherein
a refrigerant flows through the flux barrier, the gap, and the opening portion of the second rotor core.

9. The permanent magnet-type rotary electric machine according to claim 8, wherein
the refrigerant is oil or air.

10. The permanent magnet-type rotating electric machine according to claim 1, wherein
the guide portion is formed at a position facing a corner of the permanent magnet, arranged between the flux barrier region and the gap, so that a path connecting the flux barrier region to the gap region is narrowed.

11. The permanent magnet-type rotary electric machine according to claim 10, wherein
the opening portion includes a recessed portion formed on an inner surface on the radially inner side at a position facing a corner of the permanent magnet; and
the recess portion is configured as the opening portion that straddles the corner of the permanent magnet.

12. The permanent magnet-type rotary electric machine according to claim 10, wherein
the gap is formed between the inner surfaces on the radially inner side of the magnet insertion hole and the radially inner surface of the permanent magnet facing the inner surface, and the flux barrier and the gap are filled with resin.

13. The permanent magnet-type rotary electric machine according to claim 10, wherein
the magnet insertion holes and the permanent magnets are arranged in a V-shaped configuration that protrudes inward in the radial direction of the rotor.

14. The permanent magnet-type rotary electric machine according to claim 3, wherein
the magnet insertion holes and the permanent magnets are arranged in a V-shaped configuration that protrudes inward in the radial direction of the rotor.

15. The permanent magnet-type rotary electric machine according to claim 4, wherein
the magnet insertion holes and the permanent magnets are arranged in a V-shaped configuration that protrudes inward in the radial direction of the rotor.

16. The permanent magnet-type rotary electric machine according to claim 10, wherein
the magnet insertion holes and the permanent magnets are arranged in at least two layers in a radial direction of the rotor.

17. The permanent magnet-type rotary electric machine according to claim 3, wherein
the magnet insertion holes and the permanent magnets are arranged in at least two layers in a radial direction of the rotor.

18. The permanent magnet-type rotary electric machine according to claim 4, wherein
the magnet insertion holes and the permanent magnets are arranged in at least two layers in a radial direction of the rotor.

19. The permanent magnet-type rotary electric machine according to claim 5, wherein
the magnet insertion holes and the permanent magnets are arranged in at least two layers in a radial direction of the rotor.

20. The permanent magnet-type rotary electric machine according to claim 10, wherein
the permanent magnet is divided into a plurality of parts in the axial direction of the rotor, and
at least one first rotor core is arranged within a range corresponding to the axial length of one of the divided permanent magnets.
